(19) United States
(12) Patent Application Publication
(10) Pub. No.: US 2026/0366487 A1
(43) Pub. Date: Nov. 19, 2026

(54) A CASTING MOULD, A METHOD FOR CASTING AN ITEM USING SUCH A CASTING MOULD, AND AN ITEM CASTED IN SUCH A CASTING MOULD

(71) Applicant: Baettr Holding GmbH, Stade (DE)

(72) Inventor: Holger Hermann GERNHARD, Magdeburg (DE)

(21) Appl. No.: 19/613,405

(22) PCT Filed: Jan. 29, 2025
(86) PCT No.: PCT/EP2025/052181

§ 371 Date: Aug. 7, 2026

(30) Foreign Application Priority Data
Feb. 9, 2024 (EP) 24156827

(51) Int. Cl. F03D 1/06; B22C 9/06; B22C 9/10; B22C 9/24

(52) U.S. Cl. CPC F03D 1/0691; B22C 9/061; B22C 9/10; B22C 9/24; F05B 2230/21

(57) ABSTRACT

A casting mould includes a first mould part, a core part, and a second mould part. The casting mould is assembled by placing the second mould part on top of or next to the first mould part in such a way that a closed casting mould is obtained, within which the core part is enclosed and around which core part a cavity with the shape of the item to be casted is defined. The first mould part and/or the second mould part includes an outer cage and one or more contour elements arranged within the outer cage in such a way that all or at least a significant part of the inner surface of the mould part is formed by surfaces of the one or more contour elements. Furthermore, a method for casting an item using such a casting mould and an item casted using a casting mould are disclosed.

### CROSS-REFERENCE TO RELATED APPLICATIONS

The present application is the U.S. national phase entry of International Patent Application No. PCT/EP2025/052181, filed Jan. 29, 2025, which claims priority to European Patent Application No. 24156827.8, filed Feb. 9, 2024, the entire contents of all are hereby incorporated by reference.

### TECHNICAL FIELD

The present disclosure relates to a casting mould, a method for casting an item using such a casting mould, and an item, in particular a rotor hub of a wind turbine or a part of such a rotor hub, which has been casted in such a casting mould.

### BACKGROUND

The traditional casting method used for casting larger metal items is sand casting, which is probably the oldest known method of casting. In this method, sand which is mixed with a suitable chemical bonding agent, is used as the mould material. Typically, the mould comprises an upper mould part, known as the cope, and a lower mould part, known as the drag, which when assembled together form a closed mould for casting an item. Thus, the outer shape of the casted item is defined by the inner surfaces of the cope and the drag. If the item to be casted comprises hollow cavities or internal features, a third mould part, known as the core, is needed. The core is arranged between the cope and the drag in such a way that a cavity in the shape of the item to be moulded is formed within the closed mould around the cope, the outer surface of which defines the shape of an inner surface of the item to be casted.

A liquid casting material in the form of molten metal is filled into the closed mould through a suitable gating system, and when the metal has been allowed to cool, the sand mould parts are broken away, and the casted item can be removed.

Due to the relatively low cost of sand, sand casting is advantageous for large volume serial productions of relatively small castings, for example with machine-formed sand moulds. It is also advantageous for relatively small volume productions of large castings, such as wind turbine castings, with hand-formed moulds, as long as it can be accepted that the surface of the casted item usually needs some additional finishing work before the item is ready for use.

However, due to the breakdown of the sand moulds at the end of the casting process, each sand mould can only be used once. Typically, as much as 95% or even more of the used sand can be reused after a thermal or mechanical reclamation process and after adding new sand and chemical bonding agent. However, the waste from this process in the form of a remaining rest of used sand, which is chemically contaminated, must be deposited as special wastes along with a smaller amount of sand, which has been removed from the sand system as dusts. Furthermore, 3D patterns, which can be quite complicated and expensive to produce, are usually needed for shaping the sand mould parts (cope, drag and core), and this shaping of the mould parts is in itself a relatively time-consuming process. This means that producing larger series of items using sand casting may be both cumbersome and costly.

Another characteristic feature of sand casting, which makes it a less than optimal method for large-scale productions is the fact that, due to the relatively low thermal conductivity of sand, the cooling of the metal within the mould can take several days for larger items.

### SUMMARY

It is a purpose of the present disclosure to provide a casting mould and a casting method, which overcomes or at least significantly reduces the disadvantages of traditional sand casting as described above.

Thus, in a first aspect of the present disclosure, it relates to a casting mould for casting an item, such as a rotor hub of a wind turbine or a part of such a rotor hub, which casting mould comprises a first mould part, a core part, and an second mould part, wherein the casting mould is configured to be assembled by placing the second mould part on top of or next to the first mould part in such a way that a closed casting mould is obtained, within which the core part is enclosed and around which core part a cavity with the shape of the item to be casted is defined, wherein the shape of the outer surface of the core part defines the shape of an inner surface of the item to be casted, and the shape of the inner surfaces of the first mould part and the second mould part define an outer surface of the item to be casted, wherein the first mould part comprises a first outer cage and one or more first contour elements arranged within the first outer cage in such a way that all or at least a significant part of the inner surface of the first mould part is formed by surfaces of the one or more first contour elements, and/or the second mould part comprises a second outer cage and one or more second contour elements arranged within the second outer cage in such a way that all or at least a significant part of the inner surface of the second mould part is formed by surfaces of the one or more second contour elements.

Compared to traditional sand casting, the use of contour elements in the first and/or second mould part instead of the traditional drag and/or cope, respectively, means that the amount of used foundry sand, which must be deposited, is significantly reduced.

Also, it is estimated that 30-60% of the virgin sand from sand quarries, which is used for replacing the sand that cannot be reused from previous castings, can be saved if traditional sand casting is replaced by the technology according to the present disclosure. The same goes for the amount of chemical products used for binding the sand together. For the worldwide wind turbine production alone, these savings could amount to approximately 1-2 million tons of new sand (corresponding to the load of about 35-70,000 full-loaded trucks) and 100-200,000 tons of chemical products each year.

If either the first mould part or the second mould part is not configured with contour elements as described above, it may consist of a traditional drag or a cope, respectively, as known from sand casting, or it may have a completely different configuration.

It is known from traditional sand casting to use so-called chills, which are bricks, typically made from iron, steel, silicon carbide or graphite that are placed locally within the sand mould. There are two reasons for using such chills. Firstly, a rapid local cooling occurs at the location of a chill, which forms a finer-grained structure of the solidified material. Thereby, a tougher material is obtained at these locations, because the resulting finer structure of the material makes the metal stronger and with higher ductility. Secondly, chills can be used for obtaining a directional solidification of the casting material, which may be useful for preventing internal voids or porosity inside the casted item.

The contour elements of the present disclosure also have these functions. However, it is also an important aspect of the present disclosure that one of the primary functions of the contour elements is to form the shape of the item to be casted.

In an embodiment of the present disclosure, each of the first outer cage and/or the second outer cage, if present, is made of a metal, such as iron, steel, aluminium, or copper, and may be formed as one integral part or assembled from a plurality of parts.

The optimal material to be used for forming the outer cage(s) may depend on the dimensions and other characteristics, such as the melting point, of the item to be casted. Also, material costs may play a role in choosing the material for the outer cage(s). In some cases, iron or steel are optimal materials for the contour elements, because they can withstand the high temperatures within the casting mould, they have a sufficiently high thermal conductivity for obtaining the desired rapid cooling of the casting material, and they are readily shapable. In other cases, in which the weight of the casting mould is of great importance, more lightweight materials, such as aluminium may be used.

If the first and/or the second outer cage is assembled from a plurality of parts, this may be done using any suitable joining technique such as welding, clamps, screws, pins or a combination thereof. The complete first and/or second outer cage or some or all of the parts assembled to form the outer cage(s) may also be cast using any of the known casting technologies.

In an embodiment of the present disclosure, if first contour elements are present, at least 20%, at least 50%, or at least 85% of the inner surface of the first mould part is formed by surfaces of the one or more first contour elements. In an embodiment of the present disclosure, if second contour elements are present, at least 20%, at least 50%, or at least 85% of the inner surface of the second mould part is formed by surfaces of the one or more second contour elements.

Whereas the chills known from traditional sand casting are locally arranged within the sand mould and only forms a minor part (typically only a very few percent) of the inner surface thereof, in embodiments, the contour elements of the present disclosure constitutes all of the inner (casting) surface of the relevant mould part, thus eliminating the need for a sand mould in the form of a drag or a cope.

With the present disclosure, the shorter cooling time and the resulting tougher metal obtained by the chills of traditional sand casting is not a local phenomenon but applies to the item to be casted as a whole. Thus, the general cooling time of the casted item is significantly reduced, in some cases by a factor of between 2 and 5, which may, for instance, reduce the cooling time for a rotor hub for a wind turbine from more than three days to less than one day. This means that a series production of casted items can be made significantly more efficient.

Another aspect of the present disclosure, which enables a much more efficient production process than traditional sand casting, is the fact that the contour elements can be reused for a significant number of castings, such as at least 20 or 25 times. This means that the cumbersome work of using the patterns for producing a new set of sand moulds for each casting is rendered unnecessary.

Furthermore, the repeated reuse of the contour elements makes a larger series production more cost-effective, even if a set of contour elements is more expensive than a set of sand moulds.

In an embodiment of the present disclosure, if present, the one or more first contour elements and, if present, the one or more second contour elements are made from a cast, machined, or 3D printed metal, such as iron, steel, copper, or tungsten (wolfram).

The main criteria for choosing the material from which to make the contour elements is the thermal conductivity and the dimensional stability. In order to obtain the advantage of higher cooling rate, which is a purpose with the present disclosure, the material must have a thermal conductivity, which is significantly higher than that of sand. If the contour elements are to be used multiple times, which is also a purpose of the present disclosure, they must be dimensional stable through repeated cycles of heating to the relevant temperature range of the liquid metal to be cast and cooling to ambient temperature.

Like for the outer cage(s), the optimal material to be used for forming the contour elements may depend on the dimensions and other characteristics, such as the melting point, of the item to be casted, and on the material costs. In general, the same advantages and disadvantages of the individual materials apply when choosing the optimal material for the contour elements as mentioned above in relation to choosing the best material for the outer cage(s).

Also, new types of hybrid materials may be used in generative manufacturing processes, such as 3D laser sintering and 3D printing, for producing the contour elements.

In an embodiment of the present disclosure, if present, the one or more first contour elements and, if present, the one or more second contour elements or at least the surfaces thereof, which form the inner surface of the first mould part and the second mould part, respectively, are coated with a refractory coating, in embodiments a zircon coating.

Coating the surfaces of the contour elements, which form the inner surface of the mould parts and, therefore, are in direct contact with the liquid casting material, helps the contour elements to better withstand the high temperature within the casting mould and prevents the liquid casting material from merging with the contour elements.

In an embodiment of the present disclosure, if present, the one or more first contour elements and/or, if present, the one or more second contour elements are releasably mounted to the first outer cage and the second outer cage, respectively.

Mounting/fastening the first contour elements and/or the second contour elements to their respective outer cages may be necessary in order to prevent that the contour elements simply fall out of their respective outer cages due to the force of gravity. Even if the first mould part or second mould part is used as a lower part of the closed casting mould in such a way that the force of gravity tends to keep the respective contour elements in their right positions rather than removing them therefrom, it may still be advantageous to mount or fasten the contour elements to the respective outer cage so that it is ensured that they stay in place, when the liquid casting material enters the closed casting mould. If, however, the contour elements of such a lower part of the closed casting mould are made from a material with a higher density than the liquid casting material, the force of gravity may be enough to keep them in place without being fastened to the respective outer cage. This may, for instance be the case, if the contour elements are made from steel, and the liquid casting material is iron.

If the mounting of the contour elements to the respective outer cages is made releasable, it is possible to take out the contour elements from the outer cages regularly, such as after each use, for cleaning and re-coating them.

In an embodiment of the present disclosure, if present, the one or more first contour elements and/or, if present, the one or more second contour elements are releasably mounted to the first outer cage and the second outer cage, respectively, by connection elements, such as pins or screws.

The releasable mounting of the contour elements to their respective outer cages may be done using a large variety of methods, such as for instance by some kind of connection elements. Connecting pins and/or bolts have proven to constitute simple and reliable means for releasably connecting different elements to each other.

In an embodiment of the present disclosure, if present, two or more first contour elements are releasably connected to each other to form all or at least a significant part of the inner surface of the first mould part and/or, if present, two or more second contour elements are releasably connected to each other to form all or at least a significant part of the inner surface of the second mould part.

Using such configuration of the contour elements means that the inner surface of the first mould part and/or the inner surface of the second mould part (as well as the outer surface of the core part) can be assembled in a simple way by simply building them up by adding the contour elements one by one, a bit like building with LEGO bricks. Likewise, the inner surfaces of the first and/or second mould part and the outer surface of the core part can be disassembled by removing the contour elements one by one.

In an embodiment of the present disclosure, wherein, if present, the two or more first contour elements are releasably connected to each other by positive locking, i.e. by interlocking due to their respective shapes, and/or if present, the two or more second contour elements are releasably connected to each other by positive locking. i.e. by interlocking due to their respective shapes.

The easiest and fastest way to assemble or disassemble the surfaces, which are constructed by the contour elements is to simply stack them and, potentially, click them together (like LEGO bricks). This obviously requires that the individual contour elements are shaped in a way so that they are able to interlock with each other in a way so that any unwanted relative movement of the contour elements is prevented.

In an embodiment of the present disclosure, if present, the two or more first contour elements are releasably connected to each other by one or more connection elements, such as pins or bolts, and/or if present, the two or more second contour elements are releasably connected to each other by connection elements, such as pins or bolts.

In cases where it is not possible or costly efficient to shape the contour elements so that such positive locking can be obtained, or if a sufficiently strong surface cannot be obtained using that solution, the releasable connection of the contour elements to each other may be done using some kind of connection elements. Connecting pins and/or bolts have proven to constitute simple and reliable means for releasably connecting different elements to each other.

In an embodiment of the present disclosure, the second mould part substantially consists of a plane or contoured cover plate, in embodiments, made from steel and made as one continuous piece.

If the second mould part consists of a cover plate, which is placed across an upward facing opening of the first mould part, it may be in physical contact with the core part across a relatively large surface, and the buoyancy force from the core part, which is well-known from traditional sand casting, will be distributed over a large area and will therefore be more easily handled, because the upward pressure against the second mould part is reduced. In that case, it is also easy to place a pouring basin on top of the cover plate with easy access for a pouring ladle.

In an embodiment of the present disclosure, all or at least a significant part of the outer surface of the core part is made from a metal, such as iron, steel, copper, or tungsten (wolfram).

If the geometry of the item to be casted allows for removing the casted item from the casting mould without destroying or dismantling the core part, the outer surface of the core part may be made completely from such materials. Otherwise, parts of the surface may be made from such materials to obtain the previously mentioned advantages of faster cooling, a tougher material and the possibility of reusing parts of the casting mould.

Even though the surface of the core part or a significant part thereof are made from such materials, it may still be advantageous to fill up the centre part of the core part with sand or a similar material. There are several reasons why this may be the case. If the complete core part was made from solid iron or steel, there might be a risk that
the chilling/cooling effect would be too high, and the microstructure of the casted material would be damaged
the core part would be very heavy and difficult to handle within the foundry
the core part would be very expensive (but could, on the other hand, be reused a number of times)

In an embodiment of the present disclosure, at least 20%, at least 50%, or at least 85% of the outer surface of the core part is made from a metal, such as iron, steel, copper, or tungsten (wolfram).

Whereas the chills known from traditional sand casting are locally arranged on the surface of the core part and only forms a minor part (typically only a very few percent) of the outer surface thereof, a substantially larger part of the outer surface of the core part may be made from such materials in the present disclosure.

This means that the shorter cooling time and the resulting tougher metal obtained by the chills of traditional sand casting is not a local phenomenon but applies to a large part of the inner surface of the item to be casted. Thus, the general cooling time of the casted item is significantly reduced.

Furthermore, the core part or at least a significant part thereof may be reused with the same benefits as the reuse of contour elements as described above with respect to a smaller amount of used foundry sand to be disposed, less or no cumbersome work to producing new mould parts from sand, and cost-effectiveness.

In an embodiment of the present disclosure, the maximum dimension of the cavity formed within the assembled casting mould is between 0.5 meters and 6 meters, between 1 meter and 5 meters, or between 1.5 meters and 4.5 meters.

Although the casting mould as described above may be used for casting items of basically all sizes, it has proven to be especially advantageous for producing larger items with dimensions within the indicated intervals.

In a second aspect of the present disclosure, it relates to a method for casting an item, such as a rotor hub of a wind turbine or a part of such a rotor hub, which method comprises the steps of assembling a closed casting mould according to any of the present disclosure
pouring and/or pumping a liquid casting material into the cavity defined within the casting mould
letting the casting material solidify
dismounting and removing the first mould part or the second mould part from the remaining part of the casting mould
removing the core part from the remaining part of the casting mould
removing the casted item from the remaining part of the casting mould

In an embodiment of the present disclosure, the method further comprises a step of destroying, at least partially, the core part before removing it from the remaining part of the casting mould.

Depending on the three-dimensional shape of the item to be casted, it may be necessary to destroy at least a part of the core part in order to make it possible to remove the item from the casting mould, once the liquid casting material therein has solidified.

In an embodiment of the present disclosure, the casting material is iron.

Although the present method may also be used with other types of casting material, it has proven to be especially advantageous for casting iron.

In a third aspect of the present disclosure, it relates to an item, such as a rotor hub for a wind turbine or a part of such a rotor hub, which has been casted using a casting mould and/or a method as described above.

Using a casting mould and/or a method described above results in a significantly shorter cooling time than can be obtained with traditional sand casting, because the contour elements are made from materials with a lot higher thermal conductivity than sand. The higher cooling rate, in turn, results in a significantly finer microstructure and a significantly better tensile strength of the material of the casted item. These improved characteristics of the materials of items casted using a casting mould and/or a method as described in the present disclosure can be readily measured. For instance, the nodule count, i.e. the number of graphite spheres on a defined (standardised) surface, will generally be considerably higher for items cast using the casting mould and the method of the present disclosure than for items cast using classic sand casting in moulding sand. Thus, in items cast using the casting mould and the method of the present disclosure, the high nodule count will be found in all parts, which have been in contact with a contour element during the casting, whereas in traditionally casted items, this effect, if present, will only occur very locally due to the use of conventional chills.

In a fourth aspect of the present disclosure, it relates to a wind turbine comprising a rotor hub or a part of a rotor hub, which has been casted using a casting mould and/or a method as described above.

### BRIEF DESCRIPTION OF DRAWINGS

In the following, a few exemplary embodiments of the present disclosure are described in more detail with reference to the drawings, of which

FIG. 1 shows three mould parts used for traditional sand casting (prior art),

FIG. 2 illustrates schematically the parts of a casting mould according to a first embodiment of the present disclosure,

FIG. 3 illustrates schematically the parts of a casting mould according to a second embodiment of the present disclosure,

FIG. 4 illustrates schematically the parts of a casting mould according to a third embodiment of the present disclosure,

FIG. 5 illustrates schematically the parts of a casting mould according to a fourth embodiment of the present disclosure,

FIG. 6 is a partly exploded view of the casting mould shown in FIG. 5,

FIG. 7 illustrates schematically the parts of a casting mould according to a fifth embodiment of the present disclosure,

FIG. 8 illustrates schematically a rotor hub for a wind turbine according to an aspect of the present disclosure, and

FIG. 9 illustrates schematically one a half rotor hub for a wind turbine according to an aspect of the present disclosure.

### DETAILED DESCRIPTION

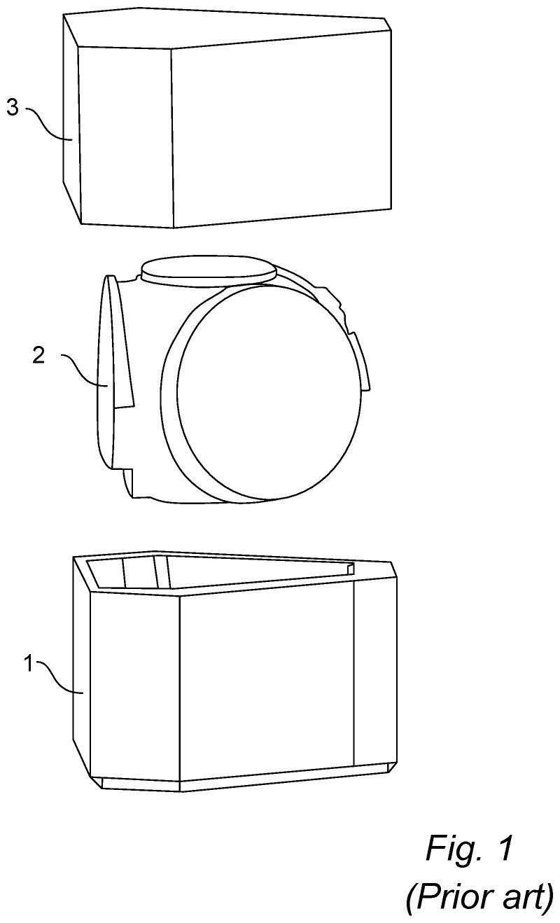

FIG. 1 shows three mould parts, in the form of a drag 1, a core part 2 and a cope 3, of a casting mould for casting a rotor hub for a wind turbine using traditional sand casting as is well-known within the art. The drag 1 and the cope 3 both consist of a mould box, also known as a flask, in which a part of the mould (not shown in the figures) has been formed in sand using a so-called pattern. The core part 2, which is to be placed within the closed casting mould, which is obtained by placing the cope 3 onto the top of the drag 1, is also formed in sand using a suitable pattern therefore.

It should be noted that, for the sake of simplicity and transparency of the figures herein, many details, which are not necessary for the understanding of the present disclosure, have been omitted. Thus, for instance, the core part 2 in FIG. 1, the outer surface of which forms the shape of the inner surface of the rotor hub to be casted within the casting mould, typically has a much more complicated shape in reality than indicated by the smooth surfaces shown in FIG. 1.

In the sand casting process, the three parts 1-3 are assembled to form a closed casting mould, into which a liquid casting material, such as molten iron or steel, is poured. When the casting material has cooled down and solidified, the mould parts, which are made of sand, are broken away in order to make it possible to remove the casted iron from the casting mould. Thus, before another item can be casted, an amount of chemically contaminated used foundry sand, must be deposited, and new mould parts must be formed in sand, which implies a significant amount of work.

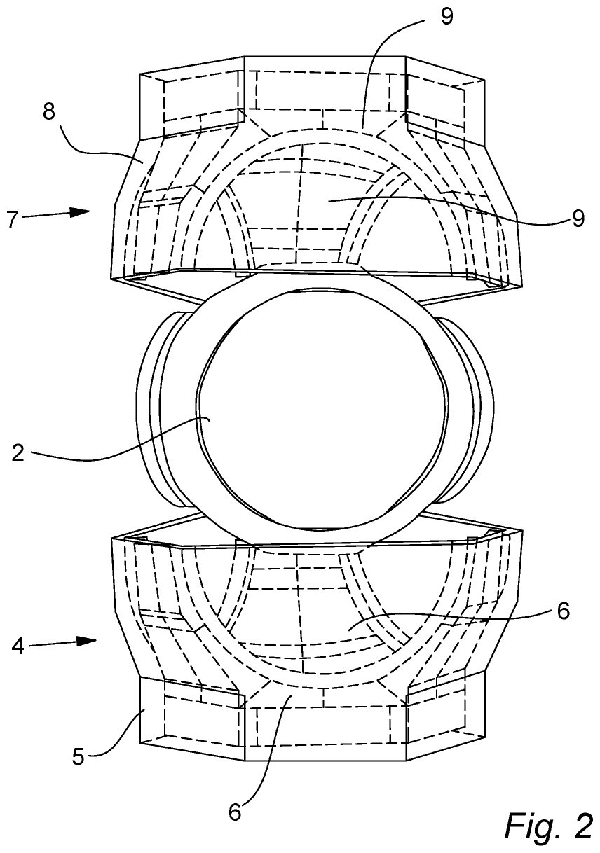

The parts of a first embodiment of a casting mould according to the present disclosure are illustrated schematically in FIG. 2. Here, the drag 1 and the cope 3 have been replaced by a first mould part 4 and a second mould part 7, respectively.

The first mould part 4 comprises a first outer cage 5, which in embodiments, is made from steel, and within which a number of first contour elements 6, in embodiments, made from iron or steel, are mounted. These first contour elements 6 fit together, similar to the pieces of a puzzle or to a plurality of Lego bricks. They are assembled to form, together with parts of the inner surface of the first outer cage 5, which are not covered by such first contour elements 6, a mould for forming the lower half of the rotor hub to be casted.

Similarly, the second mould part 7 comprises a second outer cage 8, within which a plurality of second contour elements 9 have been mounted to form, together with parts of the inner surface of the second outer cage 8, which are not covered by second contour elements 9, a mould for forming the upper half of the rotor hub to be casted.

It should be noted that although, again for the sake of simplicity and transparency, the moulding surfaces formed by contour elements 6; 9 and inner surfaces of outer cages 5; 8 seem to be identical in FIG. 2 for the first 4 and second 7 mould parts, this is typically not the case in reality, in which there may be a large difference between the shapes of the inner surfaces of the first mould part 4 and the second mould part 7, respectively.

The stylised core part 2 shown in FIG. 2 may be made from sand like in traditional sand casting, or its surface may be partly made from iron or steel as described otherwhere herein.

In the casting process using the casting mould shown in FIG. 2, the three parts 2, 4, 7 are assembled to form a closed casting mould, into which a liquid casting material, such as molten iron or steel, is poured. When the casting material has cooled down and solidified, the second mould part 7 is removed from the first mould part 4, the core part 2 is broken away or at least partly disassembled, and the casted item can be removed from the casting mould. Thus, before another item can be casted, only a smaller amount of chemically contaminated use sand must be deposited and only the core part 2 needs to be reconstructed, whereas the first mould part 4 and the second mould part 7 can be reused, potentially after cleaning and re-coating the first 6 and second 9 contour elements.

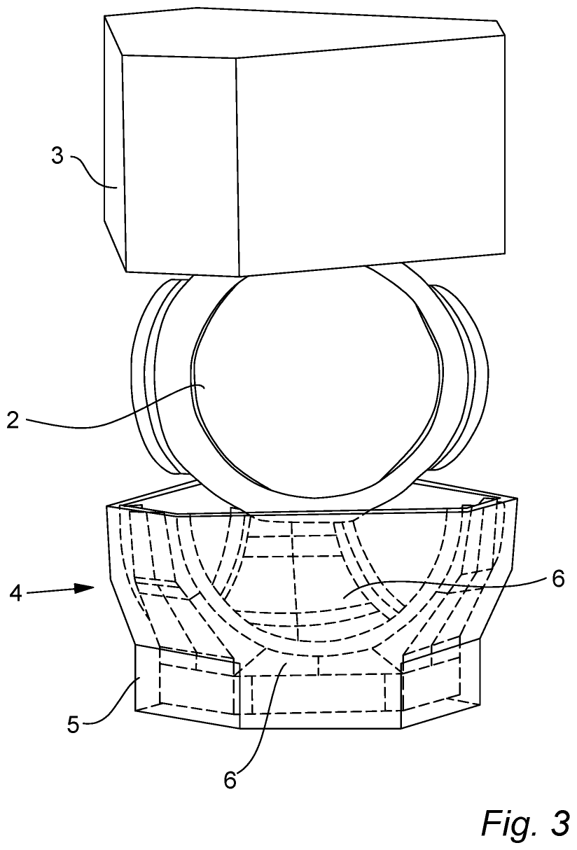

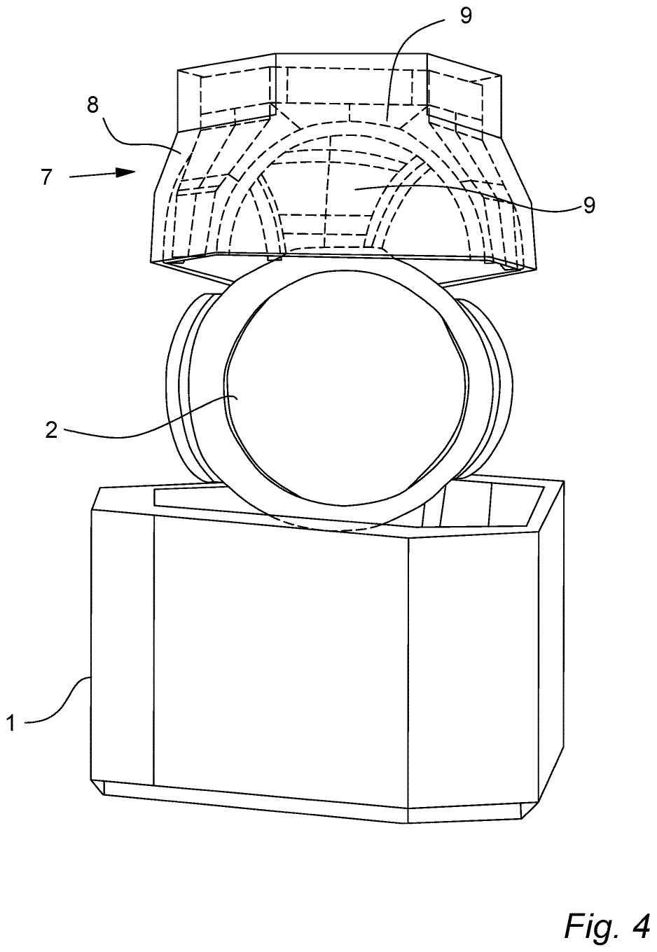

FIGS. 3 and 4 illustrate schematically the parts of two other embodiments, respectively, of a casting mould according to the present disclosure. Both of these two embodiments are partly similar to the one shown in FIG. 1. In the embodiment shown in FIG. 3, however, the drag 1 has been replaced by a first mould part 4 as the one shown in FIG. 2, whereas the uppermost part of the casting mould consists of a cope 3 as known from traditional sand casting and shown in FIG. 1. In the embodiment shown in FIG. 4, on the other hand, the cope 3 has been replaced by an second mould part 7 as the one shown in FIG. 2, whereas the lowermost part of the casting mould still consists of a drag 1 as known from traditional sand casting and shown in FIG. 1.

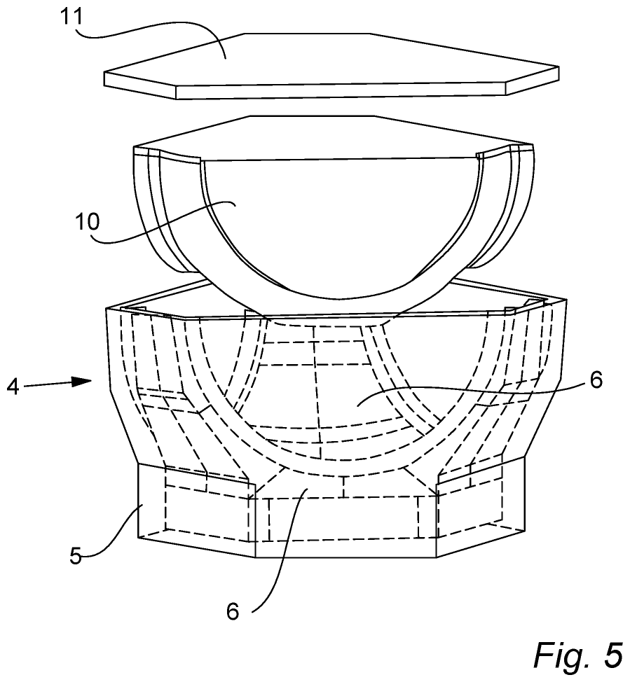

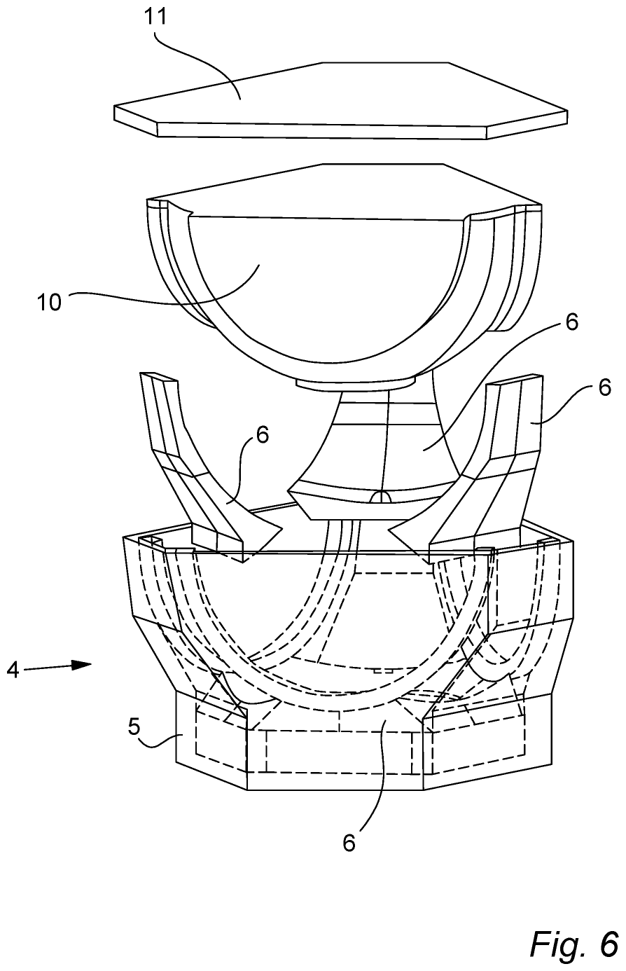

FIG. 5 illustrates schematically the parts of yet another embodiment of a casting mould according to the present disclosure, and FIG. 6 is a partly exploded view of the same embodiment of the casting mould. Whereas FIGS. 1-4 all show stylised embodiments of casting moulds for casting a full rotor hub 12 for a wind turbine, the embodiment shown in FIGS. 5 and 6 is configured for casting half a rotor hub 13 only. In the illustrated embodiment, the first mould part 4 is equal or similar to the one shown in FIGS. 2 and 3, whereas the second mould part simply consists of relatively flat cover plate 11, which can be mounted on top of the first mould part 4 for closing the casting mould. Consequently, the core part 10 to be used with such a cover plate 11 differs significantly in shape from the cover part 2 shown in FIGS. 1-4 in that its height is reduced significantly and its upper surface is flat in order to make it able to abut the cover plate 11 when the casting mould is closed. As mentioned otherwhere herein, this large contact surface between the core part 10 and the cover plate 11 means that the buoyance force acting on the core part 10 can more easily be handled than in configurations like the ones shown in FIG. 1-4.

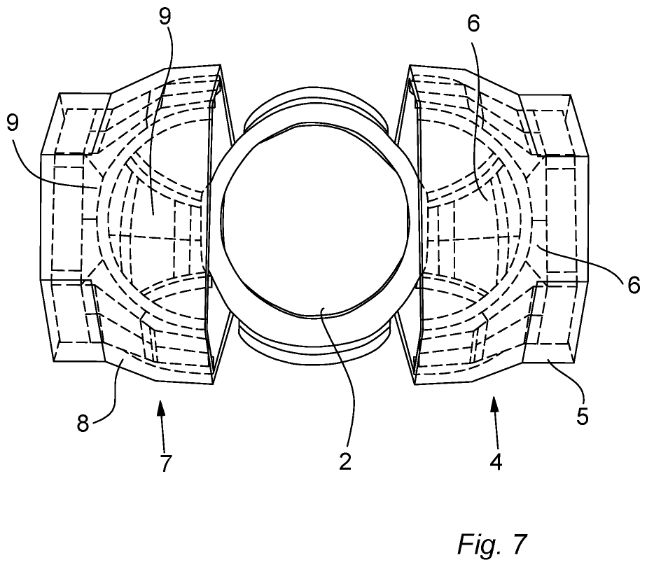

It should be noted that, just like any of the other embodiments shown in the figures, the casting mould illustrated in FIGS. 5 and 6 may be oriented differently from the orientation shown in these figures. For instance, it may be rotated 90° to obtain a configuration similar to the one shown in FIG. 7, wherein the first mould part 4 and the second mould part 7 in the form of a cover plate 11 are arranged side by side rather than on top of each other, or it may be rotated 180° to obtain an “upside-down configuration”, in which the first mould part 4 is arranged on top of the cover plate 11.

In the partly exploded view shown in FIG. 6, it is indicated how the inner surface of the first mould part 4 consists of a plurality of first contour elements 6, which are assembled and mounted within the first outer cage 5. It should be noted that, in the partly disassembled configuration shown in FIG. 6, these first contour elements 6 have not all been separated from each other. Thus, the three parts, which have been “lifted up” from the first outer cage 5, as well as the parts remaining within the first outer cage 5 each consist of a number of minor contour elements 6, which are still assembled.

The embodiment, which is illustrated in FIG. 7 is similar to the one illustrated in FIG. 2 with the very important distinction that the whole casting mould has been rotated 90°. This means that, when the casting mould is closed, the first mould part 4 and the second mould part 7 abuts each other in a substantially vertical plan, whereas in the embodiments shown in the other figures, this plan is substantially horizontal. Depending on the desired casting direction (if any) of the item to be casted and on the design of the first mould part 4, the second mould part 7, and the core part 2; 10, it may be advantageous to use a closed casting mould, in which the first mould part 4 and the second mould part 7 are not arranged primarily on top of each other but rather side-by-side as illustrated in FIG. 7.

It is to be noted that such a side-by-side configuration of the first mould part 4 and the second mould part 7 is not limited to the embodiment shown in FIG. 7 but can, in principle, be used for all embodiments of the present disclosure falling within the scope of the claims. Also, it should be noted that the side-by-side configuration may be obtained in different ways. For instance, the casting mould may be assembled from parts 4, 7, 2; 10 already oriented in the desired directions, or it may be assembled with the second mould part 7 on top of the first mould part 4 and then rotated 90° to obtain the desired orientation of the casting mould.

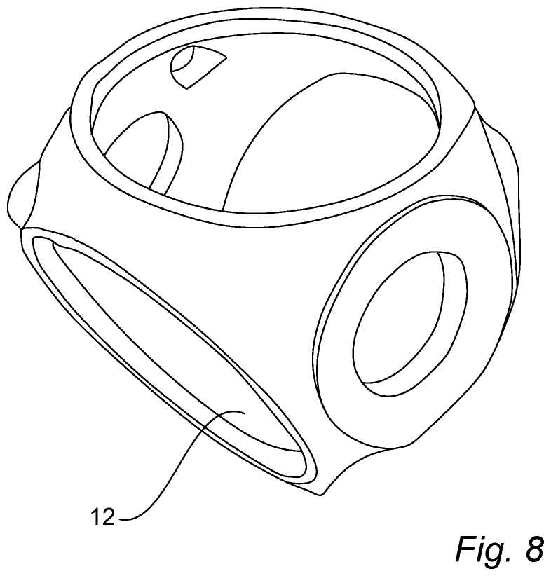

FIG. 8 illustrates schematically an example of a rotor hub 12 for a wind turbine, which may be casted using a casting mould as shown in any of FIGS. 1-4, and FIG. 9 illustrates schematically an example of a half rotor hub 13 for a wind turbine, which may be casted using a casting mould as the one shown in FIGS. 5 and 6.

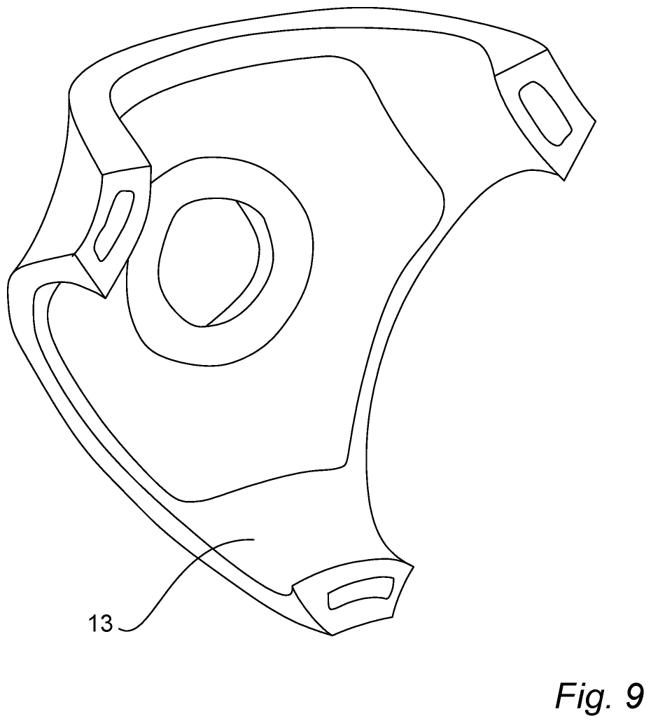

It should be noted that, after having been casted, the casted items such as a rotor hub 12 or a half rotor hub 13 for a wind turbine need surface treatment, for instance in the form of different types of machining, as well as drilling of bolt holes in flanges, etc., before they are ready for use and can be assembled with other parts, such as wind turbine blades and the like. For the sake of simplicity and clarity of the drawing, bolt holes and other details are not shown in FIGS. 8 and 9.

### LIST OF REFERENCE NUMBERS

1. Drag
2. Core part
3. Cope
4. First mould part
5. First outer cage
6. First contour element
7. Second mould part
8. Second outer cage
9. Second contour element
10. Core part to be used with cover plate
11. Cover plate
12. Rotor hub for a wind turbine
13. Half rotor hub for a wind turbine

1. A casting mould for casting an item, the casting mould comprises:
a first mould part;
a core part; and
a second mould part,
wherein the casting mould is configured to be assembled by placing the second mould part on top of or next to the first mould part in such a way that a closed casting mould is obtained, within which the core part is enclosed and around which the core part a cavity with a shape of the item to be casted is defined,
wherein a shape of an outer surface of the core part defines a shape of an inner surface of the item to be casted, and a shape of an inner surface of the first mould part and a shape of an inner surface of the second mould part define an outer surface of the item to be casted,
wherein the first mould part comprises a first outer cage and one or more first contour elements arranged within the first outer cage in such a way that all or at least a significant part of the inner surface of the first mould part is formed by surfaces of the one or more first contour elements, and/or the second mould part comprises a second outer cage and one or more second contour elements arranged within the second outer cage in such a way that all or at least a significant part of the inner surface of the second mould part is formed by surfaces of the one or more second contour elements.

2. The casting mould according to claim 1, wherein, when present, each of the first outer cage and/or the second outer cage is made of a metal, and is formed as one integral part or assembled from a plurality of parts.

3. The casting mould according to claim 1, wherein, when the first contour elements are present, at least 20%, of the inner surface of the first mould part is formed by the surfaces of the one or more first contour elements.

4. The casting mould according to claim 1, wherein, when the second contour elements are present, at least 20%; of the inner surface of the second mould part is formed by the surfaces of the one or more second contour elements.

5. The casting mould according to claim 1, wherein, when present, the one or more first contour elements and, when present, the one or more second contour elements are made from a cast, machined, or 3D printed metal.

6. The casting mould according to claim 1, wherein, when present, the one or more first contour elements and, when present, the one or more second contour elements or at least the surfaces thereof, which form the inner surface of the first mould part and the second mould part, respectively, are coated with a refractory coating.

7. The casting mould according to claim 1, wherein, when present, the one or more first contour elements and/or, when present, the one or more second contour elements are releasably mounted to the first outer cage and the second outer cage, respectively.

8. The casting mould according to claim 7, wherein, when present, the one or more first contour elements and/or, when present, the one or more second contour elements are releasably mounted to the first outer cage and the second outer cage, respectively, by connection elements.

9. The casting mould according to claim 1, wherein, when present, two or more first contour elements are releasably connected to each other to form all or at least a significant part of the inner surface of the first mould part and/or, when present, two or more second contour elements are releasably connected to each other to form all or at least a significant part of the inner surface of the second mould part.

10. The casting mould according to claim 9, wherein, when present, the two or more first contour elements are releasably connected to each other by positive locking, and/or when present, the two or more second contour elements are releasably connected to each other by positive locking.

11. The casting mould according to claim 9, wherein, when present, the two or more first contour elements are releasably connected to each other by one or more connection elements, and/or when present, the two or more second contour elements are releasably connected to each other by connection elements.

12. The casting mould according to claim 1, wherein the second mould part substantially consists of a plane or contoured cover plate.

13. The casting mould according to claim 1, wherein all or at least a significant part of the outer surface of the core part is made from a metal.

14. The casting mould according to claim 13, wherein at least 20%, of the outer surface of the core part is made from a metal.

15. The casting mould according to claim 1, wherein a maximum dimension of the cavity formed within the assembled casting mould is between 0.5 meters and 6 meters.

16. A method for casting an item, the method comprises:
assembling a closed casting mould according to claim 1;
pouring and/or pumping a liquid casting material into the cavity defined within the casting mould;
letting the casting material solidify;
dismounting and removing the first mould part or the second mould part from a remaining part of the casting mould;
removing the core part (2; 10) from the remaining part of the casting mould; and
removing the casted item from the remaining part of the casting mould.

17. The method according to claim 16, further comprising destroying, at least partially, the core part before removing the core part from the remaining part of the casting mould.

18. The method according to claim 16, the casting material is iron.

19. An item, which has been casted using a casting mould comprising a first mould part, a core part, and a second mould part,
wherein the casting mould is configured to be assembled by placing the second mould part on top of or next to the first mould part in such a way that a closed casting mould is obtained, within which the core part is enclosed and around which the core part a cavity with a shape of the item to be casted is defined,
wherein a shape of an outer surface of the core part defines a shape of an inner surface of the item to be casted, and a shape of an inner surface of the first mould part and a shape of an inner surface of the second mould part define an outer surface of the item to be casted,
wherein the first mould part comprises a first outer cage and one or more first contour elements arranged within the first outer cage in such a way that all or at least a significant part of the inner surface of the first mould part is formed by surfaces of the one or more first contour elements, and/or the second mould part comprises a second outer cage and one or more second contour elements arranged within the second outer cage in such a way that all or at least a significant part of the inner surface of the second mould part is formed by surfaces of the one or more second contour elements,
wherein the item has been casted using a method comprising:
assembling a closed casting mould according to claim 1;
pouring and/or pumping a liquid casting material into the cavity defined within the casting mould;
letting the casting material solidify;
dismounting and removing the first mould part or the second mould part from a remaining part of the casting mould;
removing the core part from the remaining part of the casting mould; and
removing the casted item from the remaining part of the casting mould.

20. A wind turbine comprising a rotor hub or a part of the rotor hub, which has been casted using a casting mould comprising a first mould part, a core part, and a second mould part,
wherein the casting mould is configured to be assembled by placing the second mould part on top of or next to the first mould part in such a way that a closed casting mould is obtained, within which the core part is enclosed and around which the core part a cavity with a shape of the rotor hub or the part of the rotor hub is defined,
wherein a shape of an outer surface of the core part defines a shape of an inner surface of the rotor hub or the part of the rotor hub to be casted, and a shape of an inner surface of the first mould part and a shape of an inner surface of the second mould part define an outer surface of the rotor hub or the part of the rotor hub to be casted,
wherein the first mould part comprises a first outer cage and one or more first contour elements arranged within the first outer cage in such a way that all or at least a significant part of the inner surface of the first mould part is formed by surfaces of the one or more first contour elements, and/or the second mould part comprises a second outer cage and one or more second contour elements arranged within the second outer cage in such a way that all or at least a significant part of the inner surface of the second mould part is formed by surfaces of the one or more second contour elements, and/or
wherein the rotor hub or the part of the rotor hub has been casted using a method comprising:
assembling a closed casting mould according to claim 1;
pouring and/or pumping a liquid casting material into the cavity defined within the casting mould;
letting the casting material solidify;
dismounting and removing the first mould part or the second mould part from a remaining part of the casting mould;
removing the core part from the remaining part of the casting mould; and
removing the casted rotor hub or the part of the rotor hub from the remaining part of the casting mould.
